(19) United States
(12) Patent Application Publication
(10) Pub. No.: US 2025/0276271 A1
(43) Pub. Date: Sep. 4, 2025

(54) Device For Obtaining Carbon Dioxide Having A Rotatable Sorption Unit

(71) Applicant: Volkswagen Aktiengesellschaft, Wolfsburg (DE)

(72) Inventors: Peter Kawelke, Wolfsburg (DE); Martin Hofer, Braunschweig (DE); Marcel Wiegel, Gardelegen (DE); Christian Heimermann, Wolfsburg (DE)

(73) Assignee: Volkswagen Aktiengesellschaft, Wolfsburg (DE)

(21) Appl. No.: 19/068,589

(22) Filed: Mar. 3, 2025

(30) Foreign Application Priority Data
Mar. 4, 2024 (DE) 10 2024 106 169.3

(51) Int. Cl. B01D 53/06; B01D 53/26

(52) U.S. Cl. CPC B01D 53/06; B01D 53/261; B01D 2253/108; B01D 2257/504; B01D 2257/80; B01D 2258/06; B01D 2259/4009

(57) ABSTRACT

The disclosure relates to a device for obtaining carbon dioxide from a gaseous medium, the device comprising a first air flow channel for a dried gaseous medium, a second air flow channel for exhaust air, and at least one rotatable sorption unit comprising at least one sorbent for physisorbing carbon dioxide. The at least one rotatable sorption unit is actuated by the first air flow channel, and the second air flow channel discharges the exhaust air from the rotating sorption unit. Furthermore, a method for obtaining carbon dioxide and the use of the device and method are disclosed.

### CROSS-REFERENCE TO RELATED APPLICATIONS

This application claims priority to German Patent Application DE 10 2024 106 169.3, filed on Mar. 4, 2024 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a device for obtaining carbon dioxide, to a method for obtaining carbon dioxide, and to the use of the device and method for obtaining carbon dioxide.

Carbon dioxide emissions into the atmosphere are currently a major driver of climate change. Carbon capture and storage (CCS) technologies are efficient and effective methods for reducing carbon dioxide emissions into the atmosphere.

Known methods for capturing carbon dioxide are absorption, adsorption, membrane-based systems, electrochemical separation, and cryogenic separation.

A further method for capturing carbon dioxide from the air is referred to as direct air capture (DAC) method. Here, carbon dioxide is sorbed from the air using a suitable sorbent and can be used for further applications.

Generally, carbon dioxide is obtained in a batch process, and therefore carbon dioxide is not acquired continuously.

SUMMARY

A need exists to provide an improved device for obtaining carbon dioxide from a gaseous medium as well as an improved method for obtaining carbon dioxide from a gaseous medium.

The need is addressed by the subject matter of the independent claim(s). Embodiments of the invention are described in the dependent claims, the following description, and the drawings.

### BRIEF DESCRIPTION OF THE DRAWINGS

FIG. 1 schematically shows an embodiment of a rotatable pre-drying unit;

FIG. 2 schematically shows an embodiment of a rotatable sorption unit;

FIG. 3 schematically shows an embodiment of a method according to the teachings herein;

FIG. 4 schematically shows an embodiment of a method according to the teachings herein;

FIG. 5 schematically shows a detail of an embodiment of a method according to the teachings herein;

FIG. 6 schematically shows an embodiment of a method according to the teachings herein; and

FIG. 7 shows the adsorption isotherms of CO₂ in an embodiment of a multi-stage sorption method.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, a device for obtaining carbon dioxide from a gaseous medium is provided, the device comprising:
a first air flow channel for a dried gaseous medium,
a second air flow channel for exhaust air,
at least one rotatable sorption unit comprising at least one sorbent for physisorbing carbon dioxide, wherein the at least one rotatable sorption unit is actuated by the first air flow channel, and the second air flow channel discharges the exhaust air from the rotating sorption unit.

In some embodiments, the gaseous medium may be the atmosphere, ambient air, exhaust gases, e.g. from industrial plants, gas mixtures, point sources, etc. The gaseous medium comprises, inter alia, carbon dioxide (CO₂).

A dried gaseous medium should be understood to mean a gaseous medium in which the moisture content, i.e., the water content, is at most 0.18%, or for example at most 0.03%, or for example at most 0.001%.

In some embodiments, the device comprises a first air flow channel for the dried gaseous medium.

In some embodiments, the device additionally comprises a second air flow channel for exhaust air. The exhaust air is for example a dried gaseous medium from which carbon dioxide has been removed.

The carbon dioxide content in the exhaust air is for example at most 100 ppm, or for example at most 50 ppm, or for example at most 10 ppm.

Furthermore, the device in some embodiments comprises at least one rotatable sorption unit comprising at least one sorbent for physisorbing carbon dioxide, wherein the at least one rotatable sorption unit is actuated by the first air flow channel and the second air flow channel discharges the exhaust air from the rotating sorption unit.

In some embodiments, the at least one rotatable sorption unit may be axially rotatable and the first air flow channel may radially actuate the at least one rotatable sorption unit.

The rotatable sorption unit is for example a sorption wheel or a sorption heat exchanger. A sorption wheel is a wheel-shaped component that is coated with a sorbent on the outside. The sorption wheel or sorption heat exchanger can rotate and a medium can flow against it, from which medium a particular substance can be sorbed by means of the sorbent.

In some embodiments, the device comprises a rotatable sorption unit. In some embodiments, the device comprises at least two rotatable sorption units.

Depending on the CO₂ product quality requirements (purity) for, for example, a particular follow-up process, it is also conceivable to restrict the CO₂ adsorption to two sorption units, such that a product flow with a CO₂ purity of approx. 75% can be provided.

In some embodiments, it is also conceivable to additionally use the CO₂-free exhaust air after CO₂ adsorption from two rotatable sorption units for regenerating the first drying unit (e.g. the pre-drying), such that at least 80%, or for example at least 85%, or for example at least 90% of the dry gaseous medium is then available for regenerating the drying unit (e.g. the pre-drying).

The at least one rotatable sorption unit may be axially rotatable, i.e., it may rotate about its own axis. The first air flow channel may radially actuate the at least one rotatable drying unit. The through-flow direction of the gaseous medium may therefore extend radially. The through-flow direction of the process and regeneration air may extend radially.

The sorbent for physisorbing carbon dioxide is for example arranged on the entire rotatable sorption unit, such that the first air flow channel directly activates the sorbent, and the dried gaseous medium, which flows through the first air flow channel, comes into direct contact with the sorbent.

On account of the rotation of the rotatable sorption unit, a part of the rotatable sorption unit comes into contact with the dried gaseous medium, and the sorbent on said part of the rotatable sorption unit can take up the carbon dioxide in the gaseous medium at least in part. On account of the rotation, the rotatable sorption unit moves further on and the part of the sorbent that is wetted with carbon dioxide can move further on to a region in which the carbon dioxide can be desorbed again from the sorbent. On account of the further rotation, the sorbent freed from carbon dioxide can be reused in order to separate carbon dioxide from the dried gaseous medium. Dried gaseous medium with a lower carbon dioxide content can thus exit the rotatable sorption unit.

The part of the rotatable sorption unit that comes into contact with the dried gaseous medium is for example up to 50% of the peripheral surface, or for example up to 45% of the peripheral surface, or for example up to 40% of the peripheral surface.

In some embodiments, the device comprises a third air flow channel, wherein the third air flow channel actuates the rotatable sorption unit.

Regeneration air can be conveyed through the third air flow channel and actuate the rotatable sorption unit. For example, the third air flow channel radially actuates the rotatable sorption unit.

If a third air flow channel is present, the part of the rotatable sorption unit that comes into contact with the dried gaseous medium may for example constitute up to 20% of the peripheral surface, or for example up to 15% of the peripheral surface, or for example up to 10% of the peripheral surface.

The first air flow channel, the second air flow channel, and the third air flow channel may be present in some embodiments. The air to be dried may be in the first air flow channel. The areal proportion of the rotatable sorption unit that is impinged upon by the first air flow channel is for example 50%, or for example 45%, or for example 40%. The regeneration air may be in the second air flow channel. The areal proportion of the rotatable sorption unit that is impinged upon by the second air flow channel is for example 50%, or for example 45%, or for example 40%. The third air flow channel may comprise the cooling-heating circuit. The areal proportion of the rotatable sorption unit that is impinged upon by the third air flow channel is for example 20%, or for example 15%, or for example 10%. The sum of the areas of the rotatable sorption unit that is impinged upon by the first, second, and third air flow channel is 100%.

The regeneration air may in some embodiments be dried gaseous medium from which carbon dioxide has been removed or which has been enriched with carbon dioxide. The carbon dioxide content is for example 50%, or for example 60%, or for example 75%. The carbon dioxide content is for example dependent on the rotatable sorption unit. If multiple rotatable sorption units are present in a device in some embodiments, the carbon dioxide content for example depends on which of the rotatable sorption units is actuated. For example, the regeneration air is at an elevated temperature, i.e., a temperature of greater than 120° C., or for example greater than 200° C., or for example greater than 250° C. The elevated temperature can be achieved by means of a heater.

In some embodiments, the rotatable sorption unit may comprise at least one heating-cooling circuit. Cooler gaseous medium can exit through the heating-cooling circuit and be used to cool the rotatable sorption unit, and the gaseous medium heated in this manner can in turn be used to pre-heat the rotatable sorption unit.

The gaseous medium in the heating-cooling circuit is for example dried air. The carbon dioxide content of the dried air for example depends on the rotatable sorption unit to be cooled or preheated.

The rotatable sorption unit may comprise a sorbent for physisorbing carbon dioxide in some embodiments. In some embodiments, the rotatable sorption unit may comprise at least two sorbents for sorbing carbon dioxide. For example, the rotatable sorption unit may comprise two sorbents for sorbing carbon dioxide, three sorbents for sorbing carbon dioxide, or four sorbents for sorbing carbon dioxide.

If more than two sorbents are used for the physisorption, be it in a rotatable sorption unit or—if present—in multiple rotatable sorption units, these may for example be coordinated with one another. It is possible for the sorbent in the rotatable sorption unit with which the dried gaseous medium comes into contact first to react less sensitively to carbon dioxide than the other sorbent or sorbents with which the dried gaseous sorbent comes into contact.

If two sorbents are present for physisorbing carbon dioxide in a rotatable sorption unit, these may for example be present in a ratio of 90:10, or for example 80:20, or for example 70:30.

If three sorbents are present for physisorbing carbon dioxide in a rotatable sorption unit, these may for example be present in a ratio of 90:5:5, or for example 80:10:10, or for example 70:15:15.

In some embodiments, the at least one sorbent for physisorbing carbon dioxide may be selected from the group consisting of zeolite, aluminosilicate, MOF (metal-organic framework), activated carbon, and a monolith coated with sorbent.

For example, the at least one sorbent for physisorbing carbon dioxide is zeolite, for example 13X zeolite.

The device according to the teachings herein may comprise a rotatable sorption unit for physisorbing carbon dioxide in some embodiments. Alternatively, the device may comprise at least two rotatable sorption units in some embodiments. For example, the device may comprise two rotatable sorption units for physisorbing carbon dioxide, three rotatable sorption units for physisorbing carbon dioxide, or four rotatable sorption units for physisorbing carbon dioxide.

The device may, in addition to at least one rotatable sorption unit, also comprise at least one conventional sorption unit for physisorbing carbon dioxide in some embodiments.

In some embodiments, the device may further comprise at least one drying unit (e.g., a dryer). The at least one drying unit may be at least one rotatable drying unit.

The drying unit is for example actuated by the gaseous medium and the gaseous medium is dried in the drying unit. Alternatively, an already pre-dried gaseous medium may also actuate the drying unit. Fine drying of the gaseous medium may take place in the drying unit when using a pre-dried gaseous medium.

A rotatable drying unit is for example a sorption wheel or a sorption heat exchanger. A sorption wheel may also be referred to herein as a sorption rotor. A sorption wheel is a wheel-shaped component that is coated with a sorbent on the outside. The sorption wheel or else sorption heat exchanger can rotate and a medium can flow against it, from which medium a particular substance can be sorbed by means of the sorbent.

If the sorption units are sorption rotors, these may for example rotate at a speed of up to 10 revolutions per minute.

In some embodiments, the device comprises a rotatable drying unit. In some embodiments, the device comprises at least two rotatable drying units.

The at least one rotatable drying unit is axially rotatable, i.e., it rotates about its own axis. The through-flow direction of the gaseous medium for example extends radially. The through-flow direction of the process and regeneration air thus for example extends radially.

In some embodiments, the at least one drying unit may comprise at least one sorbent for sorbing water.

The sorbent for sorbing water may for example be selected from the group consisting of zeolite, graphite, aluminosilicate, MOF (metal-organic framework), silica gel, and a monolith coated with sorbent.

For example, the sorbent for sorbing water is silica gel and/or zeolite, for example 13X zeolite.

The sorbent for physisorbing water is for example arranged on the peripheral surface of the (rotatable) drying unit, such that the gaseous medium comes into direct contact with the sorbent.

In the case of a rotatable drying unit and in some embodiments, on account of the rotation of said rotatable drying unit, a part of the rotatable drying unit comes into contact with the dried gaseous medium, and the sorbent on said part of the rotatable drying unit can take up the moisture, i.e., the water, in the gaseous medium at least in part. On account of the rotation, the rotatable drying unit moves further on and the part of the sorbent that is wetted with moisture can move further on to a region in which the sorbent can be dried. On account of the further rotation, the dried sorbent can be reused in order to dry the gaseous medium. Pre-dried gaseous medium can thus exit the rotatable drying unit.

The part of the rotatable drying unit that comes into contact with the gaseous medium is for example up to 50% of the peripheral surface, or for example up to 45% of the peripheral surface, or for example up to 40% of the peripheral surface.

The arrangement with a radial through-flow direction is beneficial, because a higher water partial pressure prevails in the outer radial region of the peripheral surface on the drying side and thus the adsorption of the moisture, i.e., the water, from the gaseous medium functions well at a lower flow speed. As the radius becomes smaller, the water partial pressure decreases due to the progressive water adsorption. At the same time, the flow speed increases, supporting the adsorption kinetics and thus achieving a good drying effect even at lower water partial pressures.

If at least two sorbents are present, this may be a combination of a silica gel and zeolite. For example, coarse drying of the gaseous medium can take place by means of one sorbent, and fine drying of the gaseous medium can take place by means of the second sorbent.

In this arrangement of the radial air flow and thus the radial flow against the at least one drying unit, a particular coating pattern can be applied. A sorbent for coarse drying (e.g., silica gel) is beneficial in the outer radial region, and a sorbent for fine drying (e.g., zeolite) is beneficial in the inner radial region.

A combination of at least two sorbents, i.e., at least two coatings, e.g., in the case of the rotatable drying unit, is beneficial, since it can dry the gaseous medium to an even lower dew point compared with, for example, a rotatable drying unit with only one type of sorbent coating. The allocation between the first and second coating is for example done at a ratio of 708/30% to 90%/10%, or for example in the range of from 75%/25% to 80%/20%.

The device may comprise at least one pre-conditioning unit (e.g., a pre-conditioner). A pre-conditioning unit is a component by means of which the gaseous medium can be fed in a suitable form to the further component or components, such as the at least one drying unit, e.g., a rotatable drying unit. A pre-conditioning unit may, for example, cool or heat the gaseous medium to a defined temperature. A pre-conditioning unit may compress or expand the gaseous medium by means of pressure in addition to or as an alternative to adjusting the temperature.

By using a pre-conditioning unit, the device can also be used for different climatic conditions in some embodiments (e.g., higher H₂O contents in the ambient air at a higher temperature and/or air humidity).

The pre-conditioning unit may be a rotatable pre-conditioning unit that is identical or designed similarly to the at least one drying unit.

In some embodiments, the device comprises at least one drying unit, e.g., a rotatable drying unit, and at least one sorption unit.

In the drying unit, the pre-dried gaseous medium can be dried to a particular moisture content. The drying unit for example comprises at least one suitable material by means of which the moisture content can be adjusted. The material may be distributed homogeneously in the drying unit. Alternatively, the material may also be distributed in layers in the drying unit. In particular in the case of a layered design of the drying unit, the drying unit may comprise a drying gradient. Therefore, a first layer may lead to initial drying to a particular moisture content. In another layer of the drying unit, further drying may take place to a particular moisture content. A drying unit may comprise any desired number of layers. Ideally, the layers are coordinated with one another.

The drying unit for example adsorbs 99.0% (corresponds to a dew point of −40° C. after the drying unit), or for example 99.7% (dew point −50° C.), or for example 99.9% (dew point −60° C.) of the quantity of H₂O present in the gaseous medium.

The drying unit may be designed independently of the sorption unit in some embodiments.

In some embodiments, the device may comprise at least one cooler.

The at least one cooler may for example be an intercooler.

For example, an intercooler is arranged downstream of the drying unit. An intercooler may also be arranged upstream of the sorption unit. In some embodiments, an intercooler is arranged between the drying unit and the sorption unit.

An intercooler cools the incoming (gaseous) medium for example to a defined temperature. The temperature is for example <15° C., or for example <10° C., or for example <6° C. For example, the incoming (gaseous) medium is cooled to a temperature of 5° C.

With additional and/or larger air conditioners, even greater cooling is possible downstream of the drying unit (e.g. to −20 to −40° C.).

The device may comprise at least one heat exchanger unit. The heat exchanger unit may, in particular, serve to recover heat. By using a heat exchanger unit, the energy demand supplied by external energy sources can be reduced and thus the energy efficiency of the device can be increased.

The heat recovered by the heat exchanger unit may, for example, be used for desorbing H₂O from the drying unit and/or carbon dioxide from the sorption unit.

In some embodiments, the energy demand of the device can be further reduced by using at least one heat pump. The energy for the desorption in the drying unit and/or sorption unit can be obtained by means of the heat pump. The cold exhaust air of the heat pump can be used for cooling, e.g., in the drying unit and/or intercooler.

The device may further comprise at least one blower device in some embodiments. The blower may serve to guide the gaseous medium through the device. The blower may be arranged on the inlet side and/or outlet side of the device. If the blower is arranged on the inlet side, the gaseous medium is pushed into the device (for example, into the drying unit). If the blower is arranged on the outlet side of the device, the gaseous medium is sucked through the device on account of the suction generated by the blower.

Multiple blower devices or only one blower device may be present.

For a design that is as simple as possible, it is possible to try dispensing with multiple blowers and to set the air flow allocation by means of variable throttles, as long as the additional pressure loss that results is tolerable.

The at least one drying unit and/or the at least one sorption unit may also comprise at least one physisorbent or at least one sorbent in some embodiments. A physisorbent is a compound that can bind a substance (e.g., a gas such as carbon dioxide) to it by means of physical forces. A physisorbent ideally desorbs the adsorbed substance under controlled conditions. This may take place, for example, by the action of heat, pressure, accumulation of other substances with the release of the initially adsorbed substance, etc.

The physisorbents used are for example robust, aging-resistant, and commercially available on a large scale. In comparison to chemisorbents, there are generally no signs of aging or degradation within the temperature range used.

The physisorbent may be a homogeneous substance or a mixture. For example, the at least one physisorbent is a solid. The at least one physisorbent may be selected from the group consisting of silica gel, zeolite, aluminosilicate, MOF (metal-organic framework), and a monolith coated with sorption material in some embodiments.

For example, the drying unit has a layered structure of physisorbents. In some embodiments, the drying unit comprises at least one layer of silica gel and at least one layer of zeolite. The at least one layer of silica gel is for example arranged in the inlet region of the drying unit, such that the silica gel can carry out initial drying. The medium dried in this manner is then guided through the at least one zeolite layer, such that further drying of the gaseous medium can take place.

In some embodiments of the drying unit, same comprises at least one layer of silica gel and at least two layers of zeolite. A layer of zeolite, a so-called protective layer, may be arranged in the inlet region of the drying unit. The protective layer may serve to remove impurities from the gaseous medium in order to thus protect the subsequent layers. At least one layer of silica gel may be arranged on the protective layer, such that the silica gel can carry out initial drying. The medium pre-dried in this manner is then guided through the at least one zeolite layer, such that further drying of the gaseous medium can take place.

The ratio of the first layer (e.g., silica gel) and second layer (e.g., zeolite) is for example in the range of between 1.5 and 3.5, or for example in the range of between 2.0 and 3.0, or for example in the range of between 2.3 and 2.5.

In some embodiments, the sorbent or else sorbents of the drying unit are matched to the physisorbent or else physisorbents of the drying unit.

The device is for example operated at a CO₂ partial pressure in the range of from approx. 380 to 480 ppm, or for example in the range of from 400 to 450 ppm, or for example 420 ppm. This produces a different ratio of CO₂ and H₂O partial pressure. For applications under atmospheric conditions, it can be beneficial to optimize the fill heights of the adsorption units.

For example, the drying is carried out in such a way that the medium exiting the drying unit has a moisture content of from 0.0196% to 0.007% (dew point −40° C.), or for example from 0.007% to 0.0022% (dew point −50° C.), or for example from 0.0022% to 0.0006% (dew point −60° C.).

The present disclosure further relates to a method for obtaining carbon dioxide, comprising:
providing a dried gaseous medium in a first air flow channel,
adsorbing CO₂ from the dried gaseous medium in at least one rotatable sorption unit and, at the same time, obtaining CO₂ by desorbing CO₂ in the at least one rotatable sorption unit, wherein the at least one rotatable sorption unit axially rotates and the first air flow channel radially actuates the at least one rotatable sorption unit.

The method may be a so-called direct air capture (DAC) method in some embodiments. In a DAC method, carbon dioxide is obtained by means of a suitable device from ambient air. For example, in a direct air capture method, carbon dioxide is separated from a gaseous medium, such as atmospheric air, by means of a suitable solid sorbent.

For example, the method may in some embodiments be based exclusively on continuously operating sorption units, such that a continuous CO₂ product flow can be delivered.

In continuously operating sorption units, it is easier to implement heat recovery measures. There is for example no need to use thermal stores that store the heat from a batch column from a hot cycle in order to utilize said heat in a later process step in another or the same batch column. On account of the continuous operation, unlike methods that work in batches, processes of individual adsorber columns do not need to be cyclically coordinated with one another. This would also make it easier to adjust operating parameters in the case of changing ambient conditions.

DAC methods, which are based on cyclically operating batch columns, must go through a temperature-vacuum swing process during desorption in order to achieve a high CO₂ purity in the product flow. This may necessitate high standards for the sealing of the components and assemblies in order to minimize leakage flows. By stringing together multiple continuously operating stages, the desorption could be achieved with little effort merely via the temperature.

The dried gaseous medium, first air flow channel, and rotatable sorption unit for example comprise the respective features as described herein.

The method comprises, inter alia, the step of providing a dried gaseous medium. The gaseous medium is for example air that comprises carbon dioxide.

“Dried” within the context of the gaseous medium means that the moisture content, i.e., the content of H₂O, is for example less than 120 ppm, or for example less than 40 ppm, or for example less than 10 ppm.

In some embodiments, the method comprises the step of pre-drying the gaseous medium in a pre-drying unit. Gaseous medium of the like described herein is guided through a pre-drying unit of the like described herein in a step of this kind. The pre-drying unit may thus be a rotatable pre-drying unit. It is also possible, in a method according to the teachings herein, for gaseous medium to be pre-dried in more than one pre-drying unit.

A pre-dried gaseous medium for example has a moisture content, i.e. a H₂O content, of less than 0.18%, or for example less than 0.03%, or for example less than 0.001%.

In some embodiments, the method comprises the step of drying the pre-dried gaseous medium in at least one drying unit. The drying unit is for example a drying unit of the like described herein (e.g., a dryer). The pre-dried medium, which is, in particular, guided from the at least one pre-drying unit, is guided directly, or via a further component, such as a cooler, into the at least one drying unit. The at least one drying unit is for example a rotatable drying unit of the like described herein.

The rotatable drying unit may be a sorption wheel, a sorption rotor, or else a sorption heat exchanger. A sorption wheel is a wheel-shaped component that is coated with a sorbent on the outside. The sorption wheel, sorption rotor, or else sorption heat exchanger can rotate and a medium can flow against it, from which medium a particular substance can be sorbed by means of the sorbent.

In some embodiments, the rotatable drying unit comprises at least one sorbent for adsorbing water. The sorbent may be the sorbents mentioned herein. One sorbent or a combination of at least two sorbents may be present.

In some embodiments, the at least one sorbent is a combination of two sorbents. The two sorbents may be a first layer of silica gel and a second layer of zeolite.

The drying may take place by means of at least one suitable material by means of which the moisture content can be adjusted. The material may be present as a homogeneous material. Alternatively, the material may also be present in layers. In particular if present in layers, there may be a drying gradient. Therefore, a first layer may lead to initial drying to a particular moisture content. In another layer, further drying may take place to a particular moisture content. Any desired number of layers may be present. Ideally, the layers are coordinated with one another. The layer or else layers may be at least one physisorbent of the like described herein.

During the drying, for example 99.0%, or for example 99.7%, or for example 99.9% of the H₂O present in the gaseous medium may be adsorbed.

The drying may, in particular, serve to spare the sorbent or else sorbents of the sorbent unit, above all if same has or else have an affinity to moisture.

For example, the gaseous medium is conditioned prior to the drying. The conditioning is used, in particular, to supply the gaseous medium for the method at an adequate temperature and/or adequate pressure.

In some embodiments, the method comprises cooling of the gaseous medium prior to the adsorption of the CO₂. The cooling of the gaseous medium may take place by means of an intercooler. Alternatively, other components for controlling the temperature of the gaseous medium are also conceivable. For example, it may be an air-water heat exchanger.

The incoming gaseous medium is for example cooled to a defined temperature. The temperature is for example <15° C. or for example <10° C., or for example <6° C. For example, the incoming gaseous medium is cooled to a temperature of 5° C.

The method may comprise the heat recovery step as described above.

The energy demand of the method can be further reduced in some embodiments by using at least one heat pump of the like described above.

In some embodiments, the method comprises the step of transporting the gaseous medium by means of a blower. The blower may correspond to the blower of the device according to the teachings herein.

The blower may serve to guide the gaseous medium through the device. The blower may be arranged on the inlet side and/or outlet side of the device. If the blower is arranged on the inlet side, the gaseous medium is pushed into the device (for example, into the pre-conditioning unit). If the blower is arranged on the outlet side of the device, the gaseous medium is sucked through the device on account of the suction generated by the blower.

In the method according to the teachings herein, the adsorbed CO₂ is desorbed for example by means of heating. Here, the unit in which the CO₂ is adsorbed is heated to a defined temperature. On account of the heating, the CO₂ is released from the unit and can for example be discharged with a high purity.

The CO₂ may for example be discharged from the device or else method in a purity of >80%, or for example a purity of >90%, or for example a purity of >95%. In some embodiments, the CO₂ is discharged in a purity of >99%.

The adsorbed CO₂ may be desorbed by means of heating to a temperature of >50° C., or for example >80° C., or for example >120° C., or for example >200° C., or for example >250° C. For example, no steam is required for desorbing the CO₂ in a method according to the teachings herein.

The method may further comprise the step of cooling the gaseous medium before the CO₂ is adsorbed. The cooling may take place by means of an intercooler of the like described herein.

The method may also comprise the step of guiding gaseous medium through a heating-cooling circuit. Cooler gaseous medium can exit through the heating-cooling circuit and be used, for example, to cool the rotatable sorption unit, and the gaseous medium heated up in this manner can in turn be used to pre-heat the rotatable sorption unit.

The gaseous medium in the heating-cooling circuit is for example dried air. The carbon dioxide content of the dried air for example depends on the rotatable sorption unit to be cooled or preheated.

The method may further comprise the step of cooling the gaseous medium before the CO₂ is adsorbed. The cooling may take place by means of an intercooler of the like described herein.

The method for example comprises further method steps of the like already described herein for the device.

In some embodiments, the method comprises substantially two rotatable sorption units for drying the gaseous medium (e.g., air) drawn in and three further rotatable sorption units for removing and concentrating CO₂ from the pre-dried gaseous medium (e. g., air). The incoming gaseous medium (e.g., air, such as ambient air) may be pre-dried in a first drying unit (e.g., a first sorption wheel). In this way, a majority of the water content is removed from the gaseous medium and the gaseous medium exits the first drying unit with a dew point of approx. −10° C. A rotatable pre-drying unit (e.g., a sorption wheel) with functionalization with a sorbent (e.g., silica gel) can be used for the pre-drying. Silica gel adsorbs H₂O very well in a wide partial pressure range, but lets water through at low partial pressures, and therefore a further rotatable drying unit (e.g., a sorption rotor), which is coated with a zeolite, for example with a 13X-type zeolite, is for example used for the “fine drying” of the gaseous medium. Said zeolite is capable of adsorbing water even at low partial pressures, such that the gaseous medium exits the second drying unit with a dew point of −60° C. The regeneration of the first drying unit takes place with cold, dry air, wherein approx. 83% of the originally drawn-in volume flow of the gaseous medium is used to regenerate the first drying unit. The regeneration of the second drying unit takes place with dry gaseous medium at approx. 120° C. In this way, a largely low loading with H₂O can be achieved at the end of the desorption. The low residual load of approx. 28 H₂O means that the zeolite cannot adsorb any CO₂ in this stage. The dry gaseous medium still containing CO₂ is conveyed to a first CO₂ stage. Said rotatable sorption unit may be coated with a 13X-type zeolite and can adsorb the CO₂ and, if applicable, contained residual water from the gaseous medium. The exiting gaseous medium is for example free from H₂O and CO₂ and can be used for regenerating the two drying units and the first CO₂ sorption unit. The regeneration of the CO₂ sorption unit can take place at higher temperatures of 250 to 300° C. in order to desorb any adsorbed residual water and CO₂ can thus be taken up again. The desorption may take place with a small amount of purge air used of approx. 2% of the initial volume flow in order to acquire as high a CO₂ concentration as possible from the desorption. Due to the position of the adsorption isotherms of zeolite for CO₂, a CO₂ concentration of approx. 3% can be achieved with a first CO₂ stage of this kind. This first, concentrated CO₂ flow can be conveyed to a second CO₂ sorption unit, which can, in turn, be regenerated in the desorption process with the smallest possible purge air flow at a high temperature—approx. 0.1% of the initial volume flow. As a result, a CO₂ concentration in the desorption flow of approx. 75% can be achieved. In a third stage, the adsorption and desorption may, in turn, take place according to the same principle, such that a CO₂ product flow with a concentration of 95 to 98% can be realized. If the sorption units are sorption rotors, these may rotate at a speed of up to 10 revolutions per minute.

The present disclosure further relates to the use of a device of the like described herein or of a method of the like described herein for obtaining carbon dioxide from a gaseous medium.

Reference will now be made to the drawings in which the various elements of embodiments will be given numerical designations and in which further embodiments will be discussed.

Specific references to components, process steps, other elements are not intended to be limiting. Further, it is understood that like parts bear the same or similar reference numerals when referring to alternate FIGS. The FIGS. are schematic and not necessarily to scale.

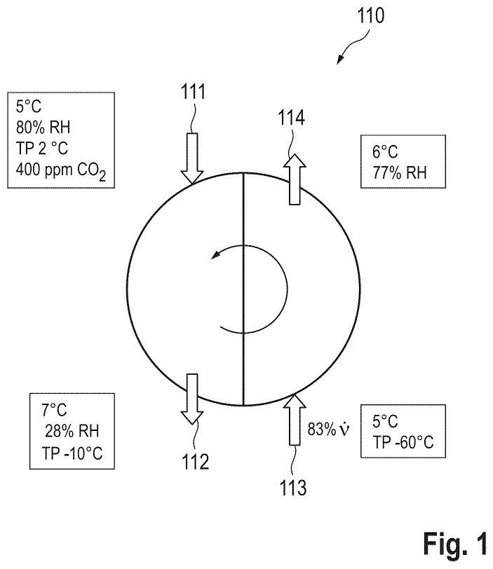

An embodiment of a rotatable pre-drying unit 110 is shown in FIG. 1. Gaseous medium, for example ambient air with a temperature of 5° C., a relative humidity of 80%, a dew point of 2° C., and a CO₂ content of 400 ppm, enters at the air inlet 111. The dried gaseous medium is guided through the rotatable pre-drying unit 110 and exits again as air discharge 112. The gaseous medium has, for example, a temperature of 7° C., a relative humidity of 28%, and a dew point of −10° C. At the same time, regeneration air 113 enters the rotatable pre-drying unit 110. The regeneration air 113 may have a temperature of 5° C. and a dew point of −60° C. The regeneration air 113 can take up moisture and heat in the rotatable pre-drying unit 110 and exit again as moist exhaust air 114. The moist exhaust air may have a temperature of 6° C. and a relative humidity of 77%. The moisture may be adsorbed in the rotatable pre-drying unit 110 by means of a sorbent, e.g. silica gel. In an alternative embodiment, a heating-cooling circuit may also be present. In FIG. 1, no heating-cooling circuit is shown, and therefore so-called cold regeneration takes place in the present case. The space allocation in the rotatable pre-drying unit 110 may be 50:50.

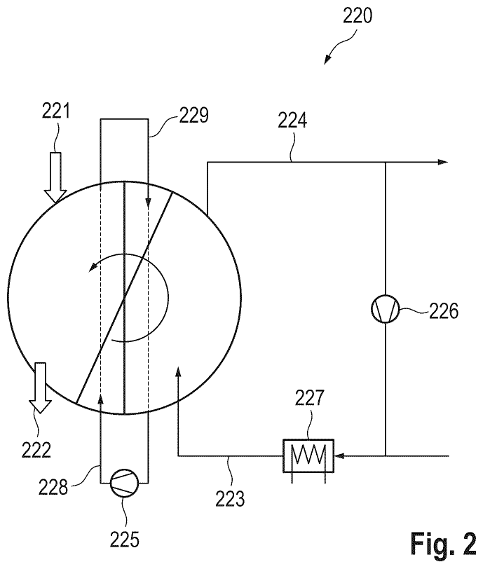

FIG. 2 shows an embodiment of a rotatable sorption unit 220. Dried gaseous medium, for example dried ambient air, enters at the air inlet 221. The dried gaseous medium is guided through the rotatable sorption unit 220 and exits again as air discharge 222. In the rotatable sorption unit 220, a substance is sorbed by means of a suitable sorbent. For example, carbon dioxide is sorbed in a rotatable sorption unit 220. At the same time, regeneration air 223 enters the rotatable sorption unit 220. The regeneration air 223 can be heated by means of a heater 227. The regeneration air 223 can take up moisture and heat in the rotatable sorption unit 220 and exit again as 224. In a heating circuit, some of the discharged air 224 is guided back via the heater 227 as regeneration air 223 via a blower 226. According to FIG. 2, the rotatable sorption unit 220 comprises a cooling-heating circuit which is guided via a blower 225. Hot air can enter through the cooling-heating circuit for the pre-heating 228. The rotatable sorption unit 220 can be preheated by means of the hot air 228 and thus the sorbed substance can be separated from the sorbent. After the air of the cooling-heating circuit has passed through the rotatable sorption unit 220, it exits again as cooler air 229 for cooling. Due to the presence of the cooling-heating circuit, the regeneration of the rotatable sorption unit 220 can also be referred to as warm or hot regeneration. The space allocation in the rotatable sorption unit 220 may be 43:7:43:7, as indicated by the lines.

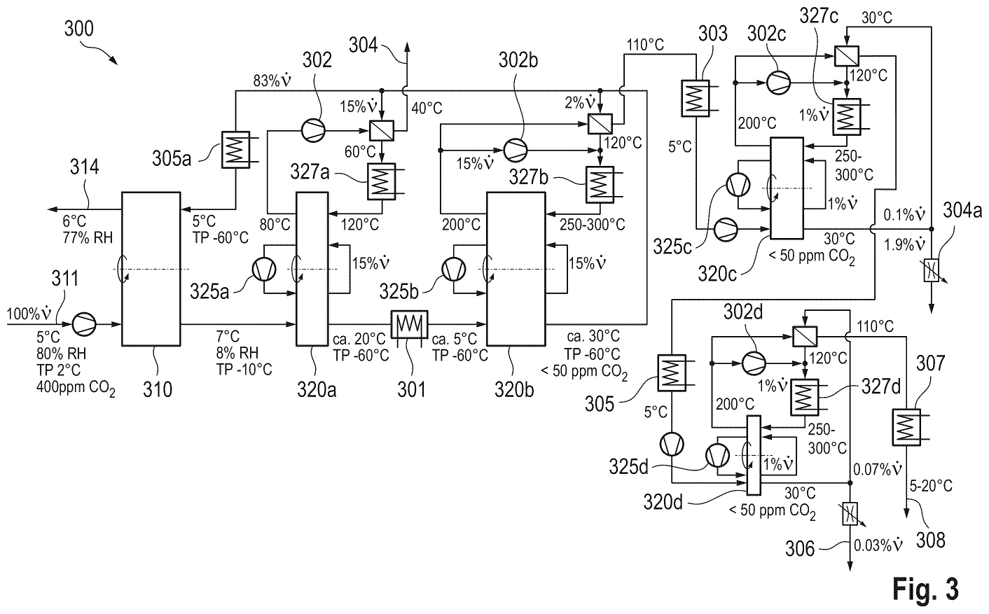

FIG. 3 schematically shows an embodiment of a device for obtaining carbon dioxide 300. The process for obtaining carbon dioxide may be a direct air capture method (DAC method). The device based on physisorbents substantially comprises a pre-drying unit 310. In this case, a rotatable pre-drying unit is shown. In the pre-drying unit 310, the sorbent for sorbing H₂O may be silica gel. As described for FIG. 1, the regeneration may be cold regeneration. Air 311 enters the pre-drying unit 310 by means of a blower. The air may have a temperature of 5° C., a relative humidity of 80%, a dew point of 2° C., and a CO₂ content of 400 ppm. Pre-dried air at a temperature of 7° C., a relative humidity of 28%, and a dew point of −10° C. may exit the pre-drying unit 310 and enter the drying unit 320a. In this case, a rotatable drying unit is shown. In the drying unit 320a, drying by means of zeolite may take place and air may exit at a temperature of 20° C. and a dew point of −60° C. The drying unit 320a may comprise a cooling-heating circuit having a blower 325a. The regeneration of the drying unit 320a may be warm regeneration, as shown in FIG. 2. The dried air from the drying unit 320a is conveyed via a cooler 301 into the rotatable sorption unit 320b. The carbon dioxide is sorbed at least partially in the rotatable sorption unit 320b and is guided out of the rotatable sorption unit 320b with a temperature of approx. 30° C., a dew point of −60° C., and a CO₂ content of less than 50 ppm. The rotatable sorption unit 320b additionally comprises a cooling-heating circuit having a blower 325b. The regeneration of the rotatable sorption unit 320b may be hot regeneration, as shown in FIG. 2. The air exiting the rotatable sorption unit 320b may be guided via a cooler 305a back to the pre-drying unit 310, in order to take up the H₂O from the pre-drying there and to exit the device as moist exhaust air 314 at a temperature of 6° C. and a relative humidity of 77%. Alternatively, the air exiting the drying unit 320a, which previously went to the blower 302 via the heat exchanger, may exit the device as moist exhaust air 304 directly and without being conveyed via a cooler. Some of the air exiting the rotatable sorption unit 320b may also be guided back via a heater 327b and a heating circuit having a blower 302b. And some of the air may also be conveyed via a heater 327a and be used to regenerate the drying unit 320a. The air from the heating circuit having a blower 302b may have a CO₂ concentration of approx. 3% and lead via a cooler 303 to a further rotatable sorption unit 320c. The rotatable sorption unit 320c additionally comprises a cooling-heating circuit having a blower 325c. The regeneration of the rotatable sorption unit 320c may be hot regeneration, as shown in FIG. 2. The air flow exiting the rotatable sorption unit 320c may have a temperature of 30° C. and a CO₂ content of less than 50 ppm. Some of the exiting air from the rotatable sorption unit 320c may be guided via a heating circuit having a blower 302c and a heater 327c. Some of the exiting air from the rotatable sorption unit 320c may exit the device as exhaust air 304a. And some of the air from the rotatable sorption unit 320c may be guided via a cooler 305 into a further rotatable sorption unit 320d. The rotatable sorption unit 320d comprises a cooling-heating circuit 325d. The regeneration of the rotatable sorption unit 320d may be hot regeneration, as shown in FIG. 2. The air exiting the rotatable sorption unit 320d may have a temperature of 30° C. and a CO₂ content of less than 50 ppm. Some of the exiting air from the rotatable sorption unit 320d may be guided via a heating circuit having a blower 302d and a heater 327d. Some of the exiting air from the rotatable sorption unit 320d may exit the device as exhaust air 306. And some exiting the rotatable sorption unit 320d may be guided via a cooler 307 as the CO₂ product flow 308. The CO₂ product flow 308 may have a CO₂ content of 95-98%.

It is also conceivable to additionally use the CO₂-free exhaust air after CO₂ adsorption from two rotatable sorption units for regenerating the first drying unit 310 (e.g. the pre-drying), such that (83+1.9+0.03)%=84.93% of dry gaseous medium is then available for regenerating the drying unit 310 (e.g. the pre-drying). The volume flow proportions for the regeneration may be as follows: 1.9% is the exhaust air from the second rotatable sorption unit 320c and 0.03% is the exhaust air from the third rotatable sorption unit 320d.

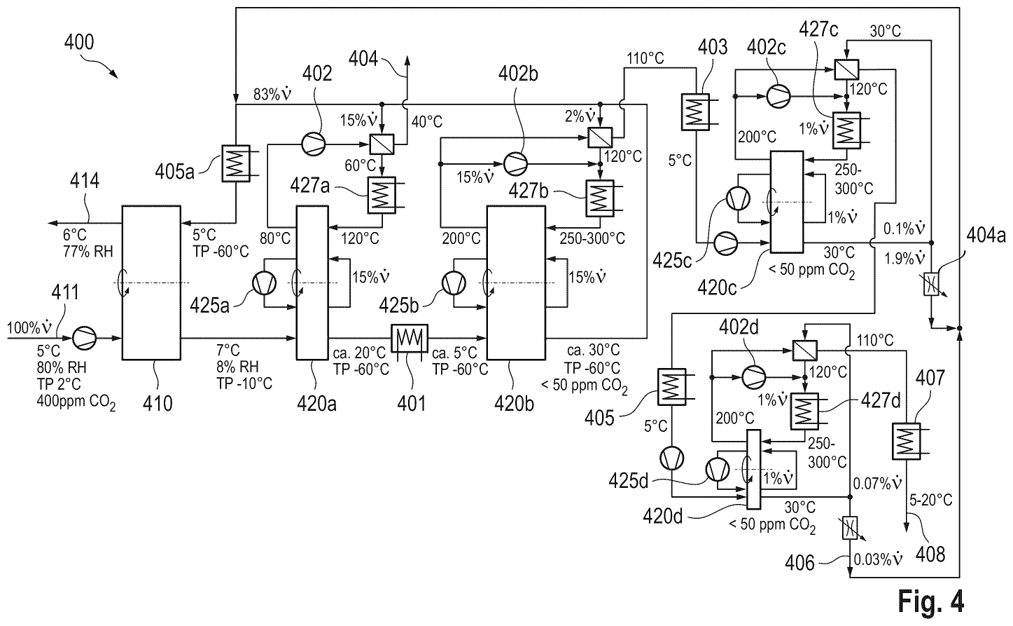

FIG. 4 schematically shows a further embodiment of a device for obtaining carbon dioxide 400. The process for obtaining carbon dioxide may be a direct air capture method (DAC method). The device based on physisorbents substantially comprises a pre-drying unit 410. In this case, a rotatable pre-drying unit is shown. In the pre-drying unit 410, the sorbent for sorbing H₂O may be silica gel. As described for FIG. 1, the regeneration may be cold regeneration. Air 411 enters the pre-drying unit 410 by means of a blower. The air may have a temperature of 5° C., a relative humidity of 80%, a dew point of 2° C., and a CO₂ content of 400 ppm. Pre-dried air at a temperature of 7° C., a relative humidity of 28%, and a dew point of −10° C. may exit the pre-drying unit 410 and enter the drying unit 420a. In this case, a rotatable drying unit is shown. In the drying unit 420a, drying by means of zeolite may take place and air may exit at a temperature of 20° C. and a dew point of −60° C. The drying unit 420a may comprise a cooling-heating circuit having a blower 425a. The regeneration of the drying unit 420a may be warm regeneration, as shown in FIG. 2. The dried air from the drying unit 420a is conveyed via a cooler 401 into the rotatable sorption unit 420b. The carbon dioxide is sorbed at least partially in the rotatable sorption unit 420b and is guided out of the rotatable sorption unit 420b with a temperature of approx. 30° C., a dew point of −60° C., and a CO₂ content of less than 50 ppm. The rotatable sorption unit 420b additionally comprises a cooling-heating circuit having a blower 425b. The regeneration of the rotatable sorption unit 420b may be hot regeneration, as shown in FIG. 2. The air exiting the rotatable sorption unit 420b can be guided via a cooler 405a back to the pre-drying unit 410, in order to take up the H₂O from the pre-drying there and to exit the device as moist exhaust air 414 at a temperature of 6° C. and a relative humidity of 77%. Alternatively, the air exiting the drying unit 420a, which previously went to the blower 402 via the heat exchanger, may exit the device as moist exhaust air 404 directly and without being conveyed via a cooler. Some of the air exiting the rotatable sorption unit 420b may also be guided back via a heater 427b and a heating circuit having a blower 402b. And some of the air may also be conveyed via a heater 427a and be used to regenerate the drying unit 420a. The air from the heating circuit having a blower 402b may have a CO₂ concentration of approx. 3% and lead via a cooler 403 to a further rotatable sorption unit 420c. The rotatable sorption unit 420c additionally comprises a cooling-heating circuit having a blower 425c. The regeneration of the rotatable sorption unit 420c may be hot regeneration, as shown in FIG. 2. The air flow exiting the rotatable sorption unit 420c may have a temperature of 30° C. and a CO₂ content of less than 50 ppm. Some of the exiting air from the rotatable sorption unit 420c may be guided via a heating circuit having a blower 402c and a heater 427c. Some of the exiting air from the rotatable sorption unit 420c may exit the device as exhaust air 404a. And some of the air from the rotatable sorption unit 420c may be guided via a cooler 405 into a further rotatable sorption unit 420d. The rotatable sorption unit 420d comprises a cooling-heating circuit 425d. The regeneration of the rotatable sorption unit 420d may be hot regeneration, as shown in FIG. 2. The air exiting the rotatable sorption unit 420d may have a temperature of 30° C. and a CO₂ content of less than 50 ppm. Some of the exiting air from the rotatable sorption unit 420d may be guided via a heating circuit having a blower 402d and a heater 427d. Some of the exiting air from the rotatable sorption unit 420d may exit the device as exhaust air 406. And some exiting the rotatable sorption unit 420d may be guided via a cooler 407 as the CO₂ product flow 408. The CO₂ product flow 408 may have a CO₂ content of 95-98%. The exhaust air 404a or else 406 may also be used to regenerate the pre-drying unit 410 and may be guided via a cooler 407, which is arranged in the CO₂ product flow 408, to the pre-drying unit 410.

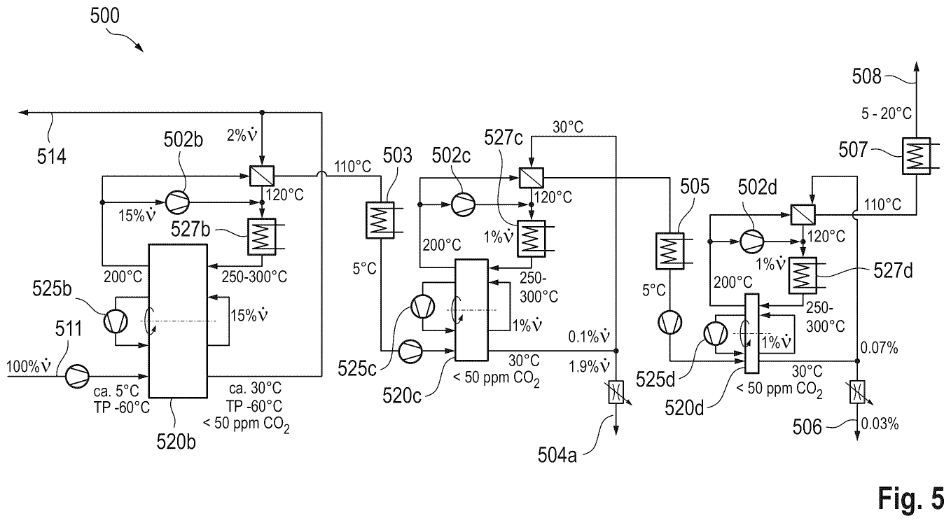

FIG. 5 shows a schematic detail from a device 500 according to the teachings herein. In contrast to the devices from FIG. 3 and FIG. 4, no pre-drying unit and no drying unit are shown. In FIG. 5, air 511 enters by means of a blower at a temperature of 5° C. and a dew point of −60° C. The air is conveyed into the rotatable sorption unit 520b. The carbon dioxide is sorbed at least partially in the rotatable sorption unit 520b and is guided out of the rotatable sorption unit 520b with a temperature of approx. 30° C., a dew point of −60° C., and a CO₂ content of less than 50 ppm. The rotatable sorption unit 520b additionally comprises a cooling-heating circuit having a blower 525b. The regeneration of the rotatable sorption unit 520b may be hot regeneration, as shown in FIG. 2. The air exiting the rotatable sorption unit 520b may exit the device as exhaust air 514. Some of the air exiting the rotatable sorption unit 520b may also be guided back via a heater 527b and a heating circuit having a blower 502. The air from the heating circuit having a blower 502b may have a CO₂ concentration of approx. 3% and lead via a cooler 503 to a further rotatable sorption unit 520c. The rotatable sorption unit 520c additionally comprises a cooling-heating circuit having a blower 525c. The regeneration of the rotatable sorption unit 520c may be hot regeneration, as shown in FIG. 2. The exiting the rotatable sorption unit 520c may have a temperature of 30° C. and a CO₂ content of less than 50 ppm. Some of the exiting air from the rotatable sorption unit 520c may be guided via a heating circuit having a blower 502c and a heater 527c. Some of the exiting air from the rotatable sorption unit 520c may exit the device as exhaust air 504a. And some of the air from the rotatable sorption unit 520c may be guided via a cooler 505 into a further rotatable sorption unit 520d. The rotatable sorption unit 520d comprises a cooling-heating circuit having a blower 525d. The regeneration of the rotatable sorption unit 520d may be hot regeneration, as shown in FIG. 2. The air exiting the rotatable sorption unit 520d may have a temperature of 30° C. and a CO₂ content of less than 50 ppm. Some of the exiting air from the rotatable sorption unit 520d may be guided via a heating circuit having a blower 502d and a heater 527d. Some of the exiting air from the rotatable sorption unit 520d may exit the device as exhaust air 506. And some exiting the rotatable sorption unit 520d may be guided via a cooler 507 as the CO₂ product flow 508. The CO₂ product flow 508 may have a CO₂ content of 95-98%.

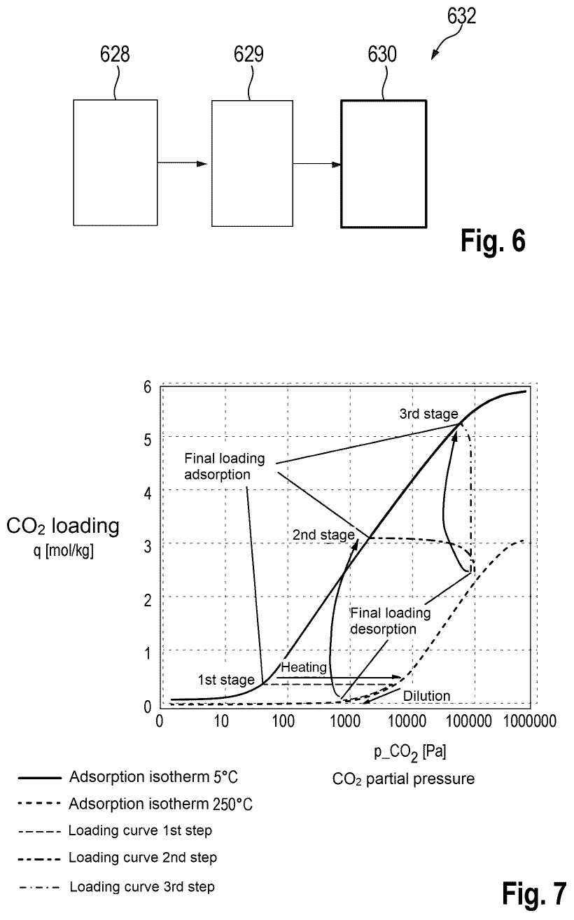

FIG. 6 schematically shows a method according to the teachings herein for obtaining carbon dioxide 632. Firstly, dried gaseous medium is provided 628 in a first air flow channel. The dried gaseous medium is transferred to a rotatable sorption unit and there the CO₂ is adsorbed 629. At the same time, CO₂ is obtained 630 by means of CO₂ being desorbed in the rotatable sorption unit. In the process, the rotatable sorption unit rotates axially and the first air flow channel radially actuates the rotatable sorption unit.

FIG. 7 shows the adsorption isotherms of CO₂ in a multi-stage sorption method, as shown, for example, in FIG. 3, FIG. 4, and FIG. 5. The CO₂ partial pressure is shown on the x-axis, while the loading with CO₂ is represented on the y-axis.

### LIST OF REFERENCE NUMERALS

110, 310, 410 Rotatable pre-drying unit
111, 311, 411, 511 Air inlet
112 Pre-drying outlet/discharge
113 Regeneration air
114, 314, 414 Moist exhaust air
514 Exhaust air
220 Rotatable sorption unit
221 Air inlet for pre-dried air
222 Air outlet/discharge after adsorption
223 Regeneration air inlet
224 Regeneration air outlet
225 Blower in cooling-heating circuit
226 Blower in heating circuit
227 Heater
228 Hot inlet for pre-heating
229 Cooler outlet for cooling
300, 400, 500 Device
301, 401 Cooler
302a, 302b, 402a, 402b, 402c, 502b, 502c, 502d Blower in heating circuit
320a, 420a H₂O adsorption unit
320b, 320c, 320d, 420b, 420c, 420d, 520b, 520c, 520d CO₂ adsorption unit
325a, 325b, 325c, 325d, 425b, 425c, 425d, 525b, 525c, 525d Blower in cooling-heating circuit
327b, 327c, 327d, 427b, 427c, 427d, 527b, 527c, 527d Heater
303, 403, 503 Cooler
304, 304a, 404, 404a, 504, 504a Exhaust air
305, 305a, 405, 505 Cooler
306, 406, 506 Exhaust air
307, 407, 507 Cooler
308, 408, 508 CO₂ product flow

The invention has been described in the preceding using various example embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments. The terms “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1. A device for obtaining carbon dioxide from a gaseous medium, comprising:
a first air flow channel for a dried gaseous medium;
a second air flow channel for exhaust air;
at least one rotatable sorption unit comprising at least one sorbent for physisorbing carbon dioxide; wherein
the at least one rotatable sorption unit is actuated by the first air flow channel, and the second air flow channel discharges the exhaust air from the rotating sorption unit.

2. The device of claim 1, further comprising a third air flow channel, wherein the third air flow channel actuates the rotatable sorption unit.

3. The device of claim 1, wherein the rotatable sorption unit comprises at least one heating-cooling circuit.

4. The device of claim 1, wherein the rotatable sorption unit comprises at least two sorbents for sorbing carbon dioxide.

5. The device of claim 1, wherein the at least one sorbent is selected from the group consisting of zeolite, aluminosilicate, MOF (metal-organic framework), activated carbon, and a monolith coated with sorbent.

6. The device of claim 1, comprising at least two rotatable sorption units.

7. The device of claim 1, further comprising at least one drying unit.

8. The device of claim 6, wherein the at least one drying unit is a rotatable drying unit.

9. The device of claim 6, wherein the at least one drying unit comprises at least one sorbent for sorbing water.

10. The device of claim 8, wherein the sorbent is selected from the group consisting of zeolite, graphite, aluminosilicate, MOF (metal-organic framework), and silica gel.

11. The device of claim 1, further comprising at least one cooler.

12. A method for obtaining carbon dioxide, comprising:
providing a dried gaseous medium in a first air flow channel;
adsorbing CO2 from the dried gaseous medium in at least one rotatable sorption unit and, at the same time, obtaining CO2 by desorbing CO2 in the at least one rotatable sorption unit; wherein
the at least one rotatable sorption unit axially rotates and the first air flow channel radially actuates the at least one rotatable sorption unit.

13. The method of claim 12, further comprising pre-drying the gaseous medium in a pre-drying unit.

14. The method of claim 13, further comprising drying the pre-dried gaseous medium in at least one drying unit.

15. A method of using the device of claim 1 for obtaining carbon dioxide from a gaseous medium.

16. The device of claim 2, wherein the rotatable sorption unit comprises at least one heating-cooling circuit.

17. The device of claim 2, wherein the rotatable sorption unit comprises at least two sorbents for sorbing carbon dioxide.

18. The device of claim 3, wherein the rotatable sorption unit comprises at least two sorbents for sorbing carbon dioxide.

19. The device of claim 2, wherein the at least one sorbent is selected from the group consisting of zeolite, aluminosilicate, MOF (metal-organic framework), activated carbon, and a monolith coated with sorbent.

20. The device of claim 3, wherein the at least one sorbent is selected from the group consisting of zeolite, aluminosilicate, MOF (metal-organic framework), activated carbon, and a monolith coated with sorbent.
